(19) United States
(12) Patent Application Publication
(10) Pub. No.: US 2011/0223793 A1
(43) Pub. Date: Sep. 15, 2011

(54) PLUG CONNECTOR

(75) Inventors: Daniel Bischoff, Buttelborn (DE); Christian Eberwein, Altlussheim (DE)

(73) Assignee: Tyco Electronics AMP GmbH, Bensheim (DE)

(21) Appl. No.: 13/130,372

(22) PCT Filed: Nov. 23, 2009
(86) PCT No.: PCT/EP2009/065632

§ 371 Date: May 20, 2011

(30) Foreign Application Priority Data
Nov. 26, 2008 (DE) 102008058867.9

(51) Int. Cl. H01R 13/625

(52) U.S. Cl. 439/347

(57) ABSTRACT

The invention relates to a plug connector with a first plug housing and a second plug housing which are plugged into each other, wherein there is provided in the first plug housing a contact-securing means which can be brought from a pre-locking position into an end position in which the contact-securing means protects contacts of the first plug housing from accidental detachment, there being movably mounted on the second plug housing an actuating means which is operatively connected to the first plug housing. The first and the second plug housing being plugged together as a result of a movement of the actuating means from an open position into an end position, and the contact-securing means has an obstructing element, the obstructing element protruding into the path of movement of the actuating means or the first plug housing and preventing plugging-together of the first plug housing and the second plug housing when the contact-securing means is not in the end position.

The invention relates to a plug connector with a first and a second plug housing which are plugged into each other, a contact-securing means in the form of what is known as a second securing means being provided in the first plug housing. In addition, the invention relates to a first plug housing with a contact-securing means.

Various plug connectors with a first and a second plug housing and also first plug housings with a contact-securing means are known in the art.

Plug connectors with a first and a second plug housing are also known in the art, there being provided an actuating means, actuation of which causes the first and the second plug housing to be plugged together.

U.S. Pat. No. 4,959,023 discloses an electric plug connector having a first and a second plug housing. A contact-securing means, which can be inserted into the first plug housing into a pre-locking position, is also provided. In the pre-locking position, the contact-securing means obstructs the insertion of the second plug housing. The contact-securing means can be slid into an end position, so that an insertion space is cleared, so that plugging-together of a first and a second plug housing is possible.

The object of the invention is to provide an improved plug connector and an improved first plug housing.

The object of the invention is achieved by the plug connector according to claim 1 and by the first plug housing according to claim 15.

Further advantageous embodiments of the plug connector are specified in the dependent claims.

An advantage of the plug connector consists in the fact that plugging-together of the first and the second plug housing with the aid of the actuating means is possible only once the contact-securing means of the first plug housing is in an end position and thus the contacts of the first plug housing are protected from accidental detachment.

The object is achieved, in accordance with the plug connector according to claim 1, in that the contact-securing means has an obstructing element which is located in a path of movement of the second plug housing or the actuating means when the contact-securing means is not in the end position. The arrangement of the obstructing element prevents the first and the second plug housing from being able to be plugged together with the aid of the actuating means without the contact-securing means being in the end position.

A further embodiment provides first locking means with which the contact-securing means are held on the first plug housing in a pre-locking position. This allows the contact-securing means to be pre-mounted in the pre-locking position and captively fastened to the first plug housing.

A further embodiment provides second locking means with which the contact-securing means locks to the plug housing in the end position. This ensures that the contact-securing means does not become detached again after reaching the end position. Subsequently, the first and the second plug housing can be plugged together without difficulty with the aid of the actuating means.

In a further embodiment, the obstructing element has a recess into which a guide element of the first plug housing protrudes.

In a further embodiment, the first plug housing has a depression in a region which is arranged, in the plugged-together state, in the second plug housing. In addition, the obstructing element is arranged, in the pre-locking position, at least partially outside the depression. In the end position of the contact-securing means, the obstructing element is arranged at least partially in the depression, so that the first plug housing can be inserted with relatively little clearance with the obstructing element into the second plug housing. In a further embodiment, the first plug housing has two parallel guide webs which laterally guide at least a partial portion of the obstructing element. Secure guidance of the contact-securing means and the obstructing element is thus possible.

In a further embodiment, the contact-securing means is embodied in the form of an angled sliding element, a first partial portion having a securing plate which is inserted into the first plug housing for securing the contacts. The second partial portion is embodied as the obstructing element. The embodiment of the contact-securing means in the form of an angled sliding element is economical and simple to produce and offers, in addition, secure handling.

In a further embodiment, the contact-securing means has a two-armed bracket for holding the contact-securing means on the first plug housing. The brackets surround in this case the first plug housing at two opposing sides and are used for locking in the pre-locking position and in the end locking position.

In a further embodiment, the obstructing element is in the form of a plate which is angled on both sides, the angled partial plates laterally at least partially surrounding the first plug housing. Additional guidance and securing of the obstructing element on the first plug housing is thus possible.

The invention will be described hereinafter with reference to the figures, in which:

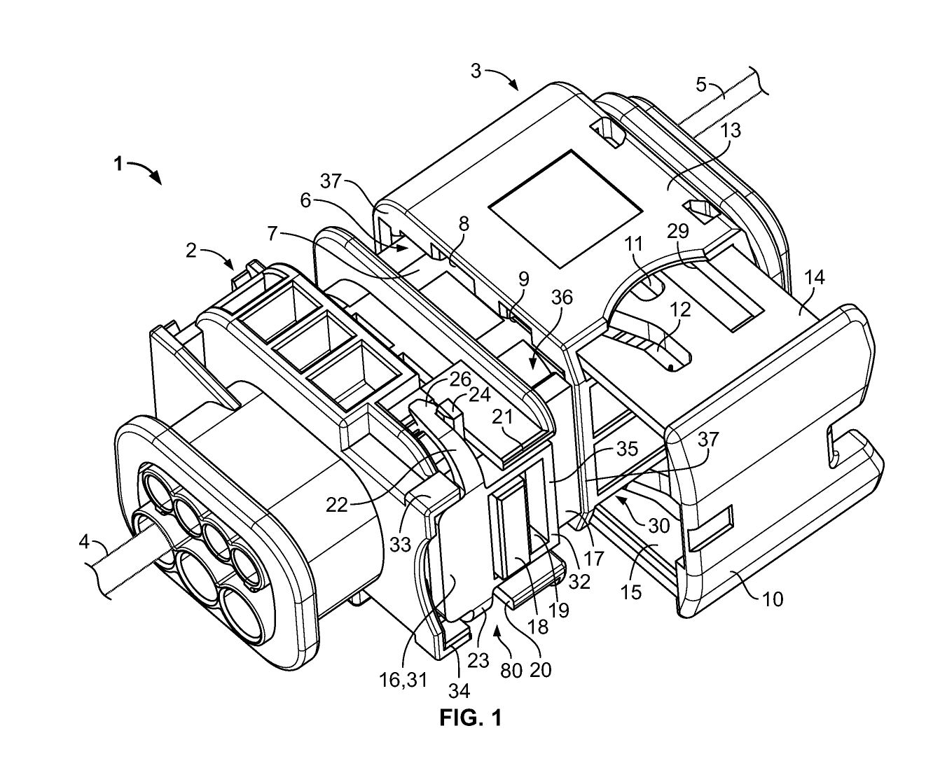

FIG. 1 shows a plug connector;

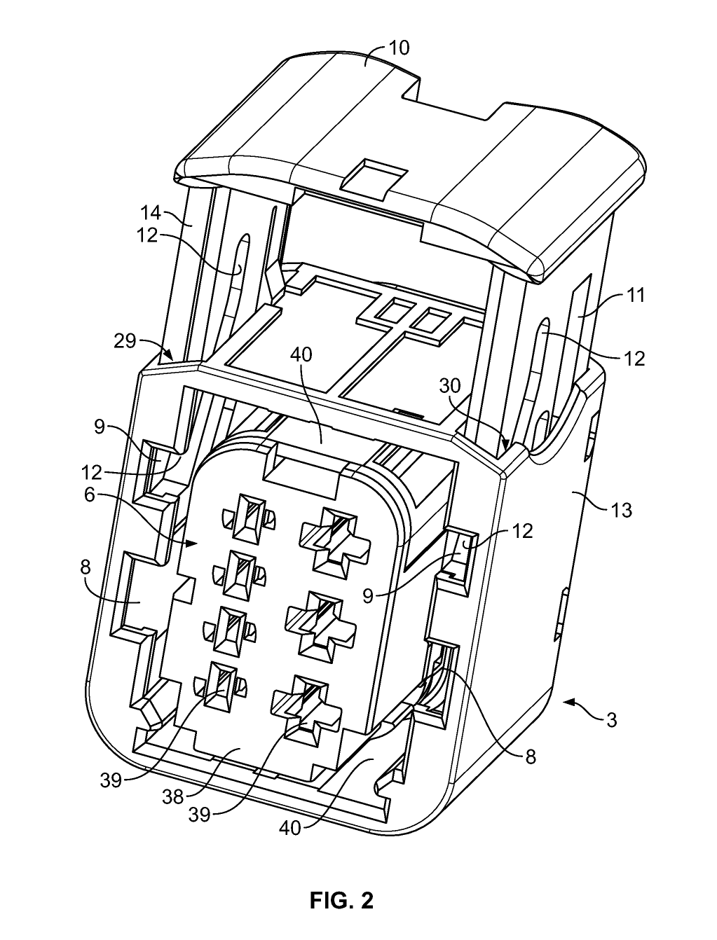

FIG. 2 shows a second plug housing;

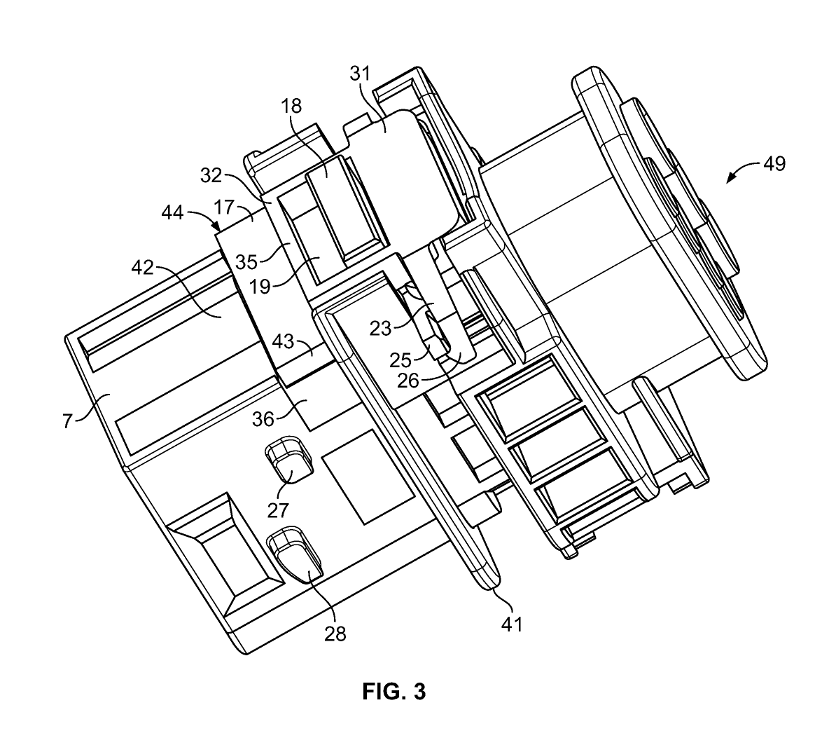

FIG. 3 shows a first plug housing with the contact-securing means in the pre-locking position;

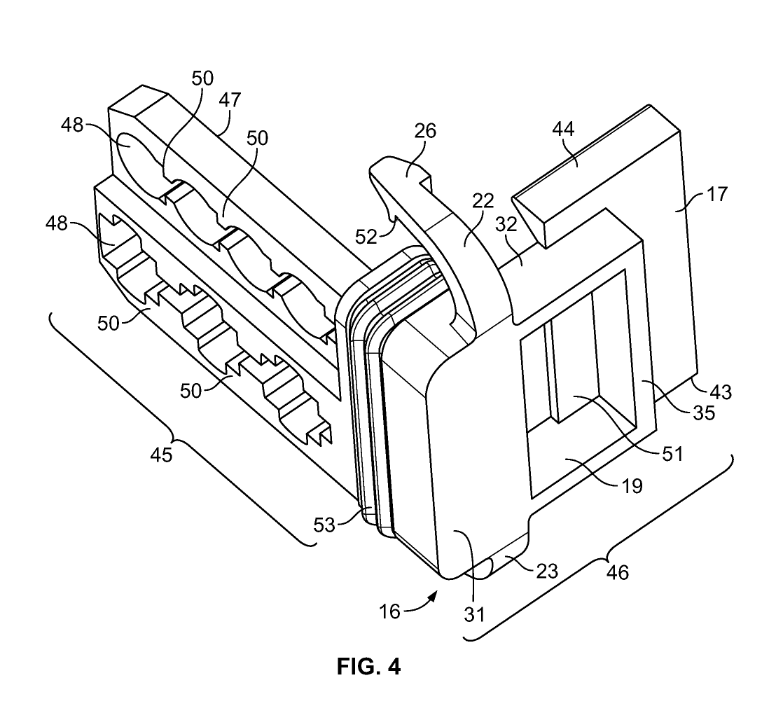

FIG. 4 shows the contact-securing means;

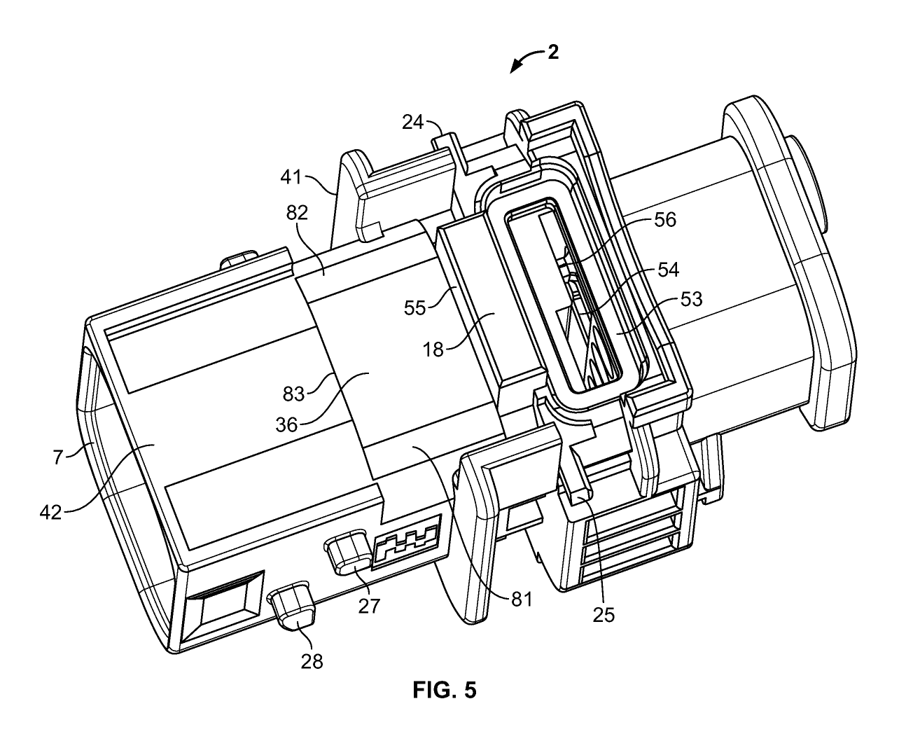

FIG. 5 shows the first plug housing without the contact-securing means;

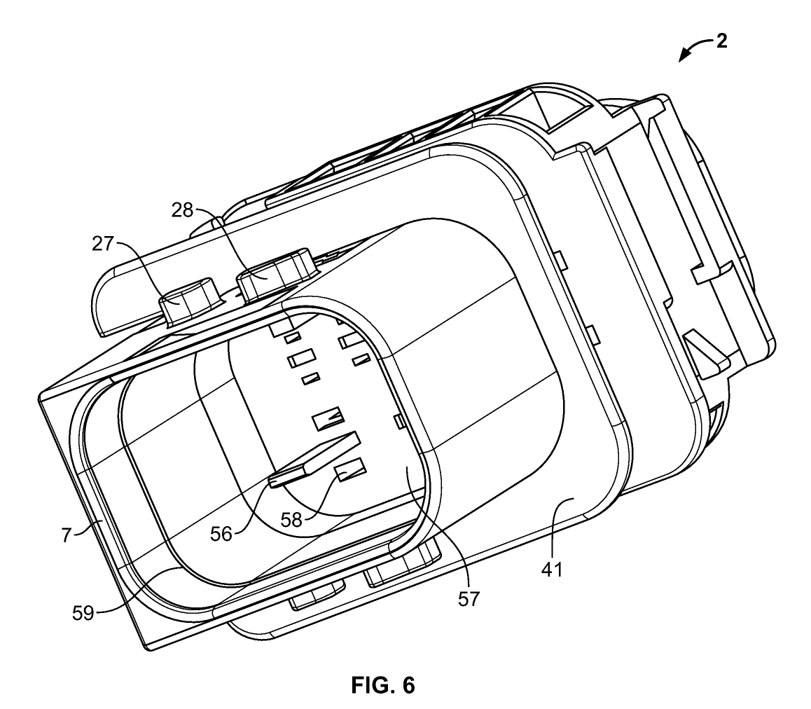

FIG. 6 shows the first plug housing looking onto the plug-in side;

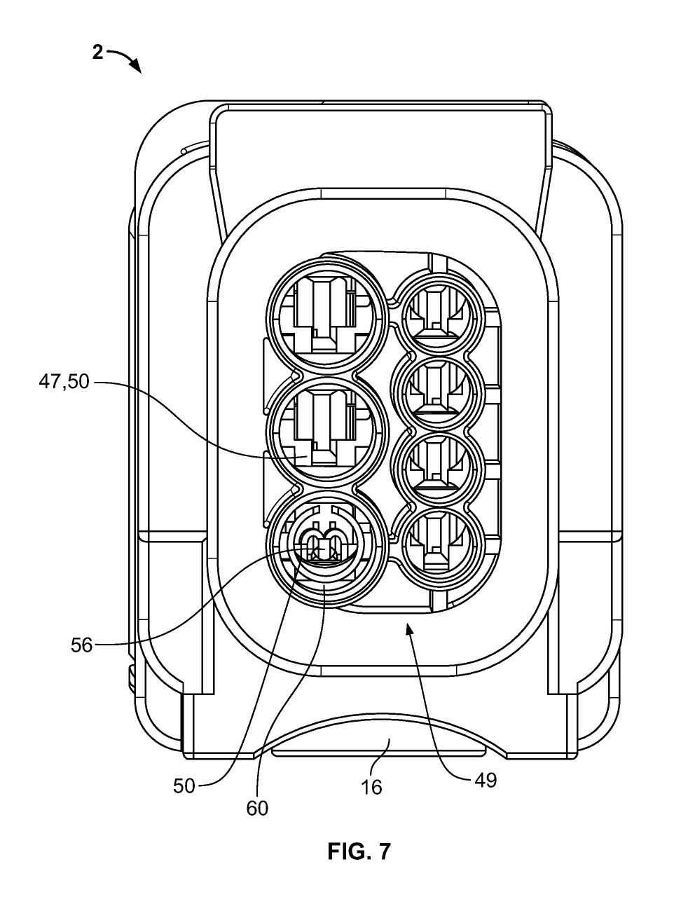

FIG. 7 shows the first plug housing looking onto the connection side;

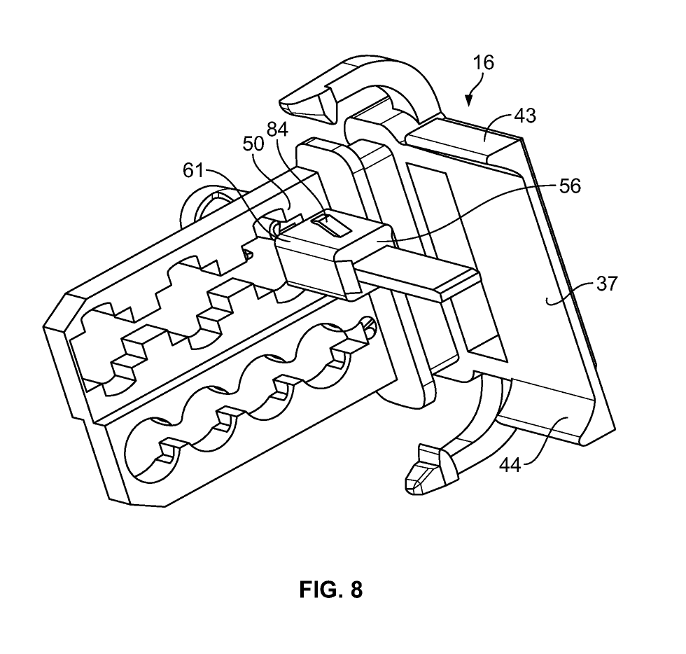

FIG. 8 is a schematic view of a contact with the contact-securing means in the end position;

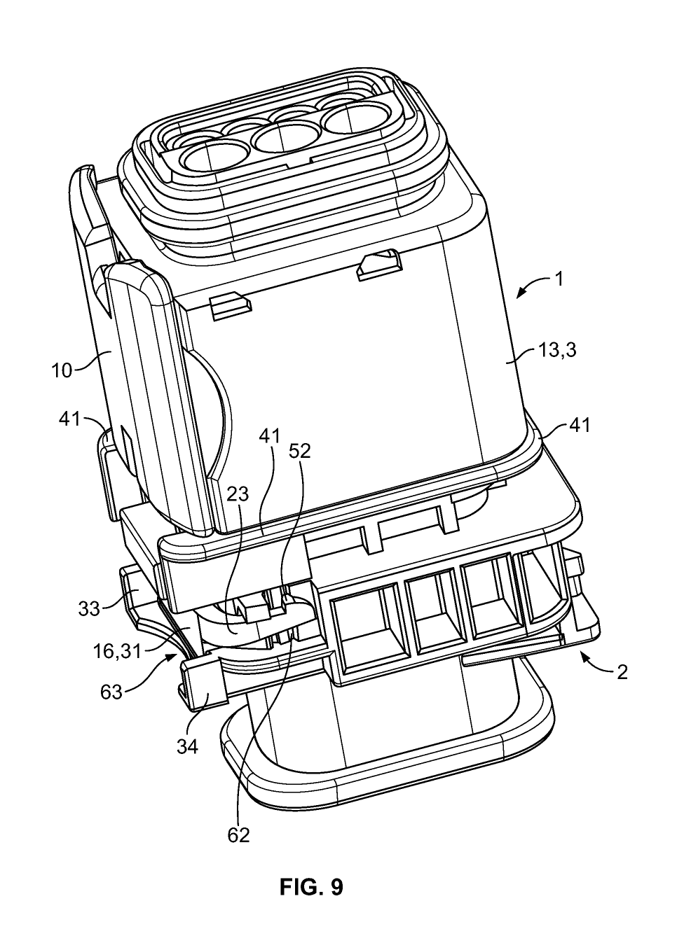

FIG. 9 is a perspective view of the mounted plug connector;

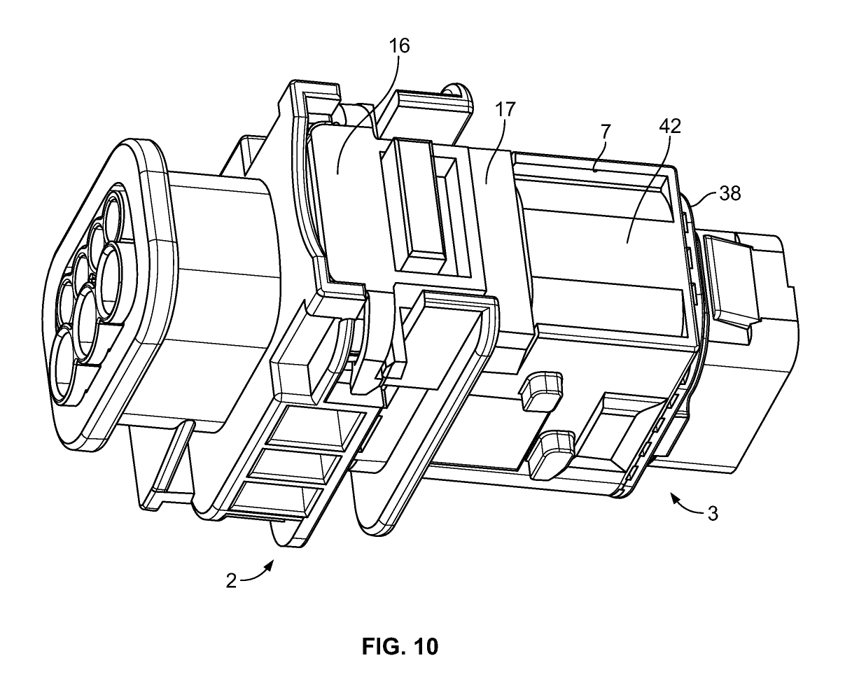

FIG. 10 shows parts of the mounted plug connector;

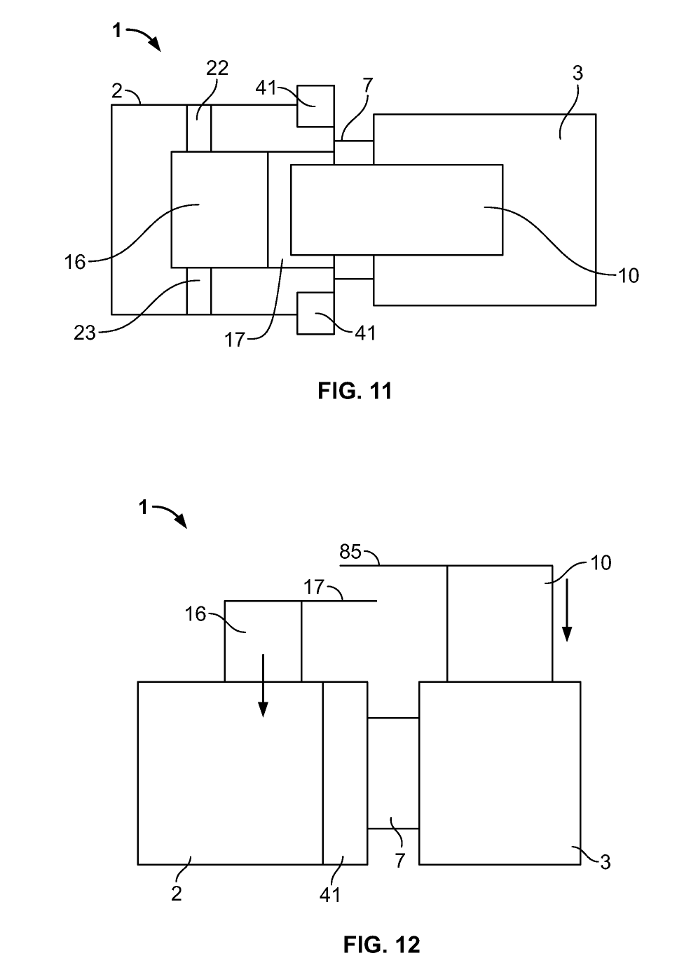

FIG. 11 shows a further embodiment of a plug connector;

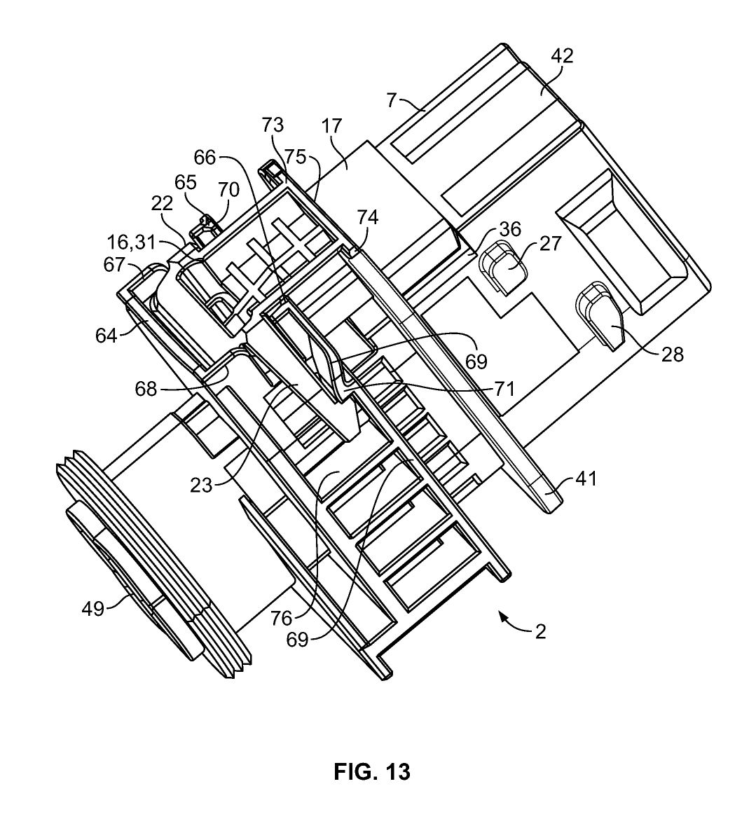

FIG. 12 is a side view of the plug connector from FIG. 11;

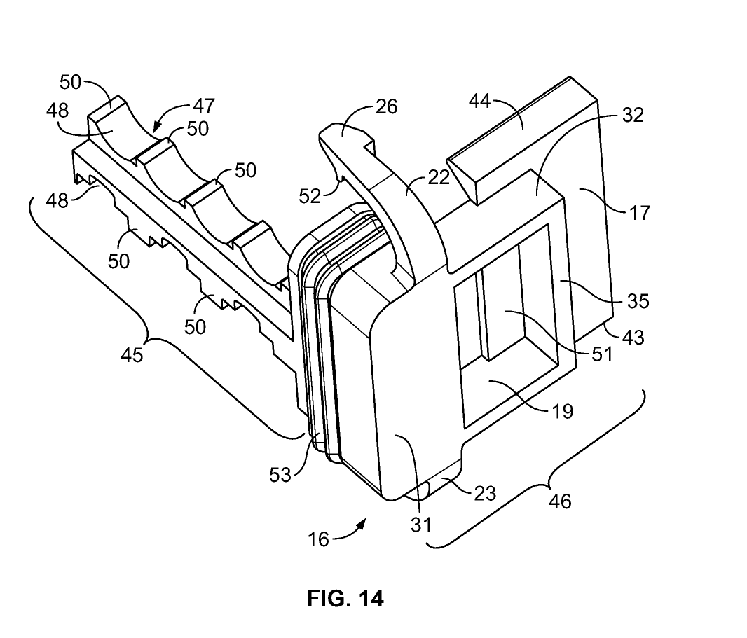

FIG. 13 shows a further embodiment of a first plug housing; and

FIG. 14 shows a further embodiment of the interlocking plate.

FIG. 1 is a perspective view of a plug connector 1 with a first plug housing 2 and a second plug housing 3. Electrical contacts, which are connected to electric first lines 4, are arranged in the first plug housing 2. Further electrical contacts, which are connected to electric second lines 5, are arranged in the second plug housing 3. For electrically contacting the contacts of the first plug housing 2 and the further contacts of the second plug housing 3, the first plug housing 2 is plugged with a front part 7 into a receiving opening 6 of the second plug housing 3. The front part 7 has guide lugs which are inserted into the first or the second guide groove 8, 9 of the second plug housing 3. The first and the second guide groove 8, 9 are arranged on an inside of a housing frame of the second plug housing 3 and are connected to the receiving opening 6.

The second plug housing 3 has an actuating element 10 in the form of a sliding element which protrudes laterally into the second plug housing 3 with two guide arms 14, 15. The guide arms 14, 15 are inserted into lateral slots 29, 30 of the housing frame 13. The two guide arms 14, 15 protrude laterally into the receiving opening 6. The two guide arms 14, each have a first and a second guide track 11, 12 which open, in the illustrated pre-locking position of the actuating element 10, into the guide grooves 8, 9 and receive the guide lugs of the front part 7. The first and the second guide track 11, 12 and the guide lugs are embodied in such a way that, during lateral insertion of the actuating element 10 into the second plug housing 3, the guide lugs in the guide tracks 11, 12 are drawn deeper into the second plug housing 3. Thus, the first plug housing 2 is also drawn deeper into the second plug housing 3 until, in the end position of the actuating element 10, the contacts of the first plug housing 1 are in contact with the further contacts of the second plug housing 3. The sliding direction for the actuating element 10 is perpendicular to the insertion direction for the first plug housing 2.

On the first plug housing 2, there is provided on a narrow side face a contact-securing means 16 with which the electrical contacts of the first plug housing 2 can be protected from extraction in the form of a second securing means. The contact-securing means 16 has a plate 31 which merges with a frame 32. The frame 32 surrounds a recess 19 in which a guide element 18 of the first plug housing 2 is arranged. In the illustrated embodiment, the recess 19 is square in its embodiment, the guide element 18 being embodied in the form of a rectangular block. In addition, the frame 32 is delimited at opposing side rims by a first or a second guide wall 20, 21 of the first plug housing 2. Furthermore, the first plug housing 2 has, adjoining a connection-side side rim of the plate 31, two guide corners 33, 34 which are associated with corner regions of the plate 31.

Opposite the plate 31, an obstructing element 17, which extends in the direction toward the second plug housing 3, is embodied on a front-side frame part 35. The obstructing element 17 is arranged above a depression 36 of a first narrow side 80 of the front part 7. The obstructing element 17 extends up to a front-side edge region 37 of the second plug housing 3. The contact-securing means 16 has, laterally emanating from the plate 31, two holding brackets 22, 23 which extend from the first narrow side 80 of the first plug housing 2 in the direction toward a first or second wide side of the first plug housing 2. A first and a second holding web 24 are embodied on the first and second wide sides of the first plug housing 2. In the pre-locking position of the contact-securing means 16, which is shown in FIG. 1, a first locking lug 26 of the first holding bracket 22 reaches behind the first holding web 24 or a second locking lug (not shown) reaches behind the second holding web (not shown). The contact-securing means 16 is thus protected from detachment. Owing to the lateral guide walls 20, 21 and the guides in the form of the guide corners 33, 34 and the arrangement of the guide element 18 in the recess 19, displacement of the contact-securing means in the plane of the first narrow side is not possible. The contact-securing means 16 does not rest, in the illustrated pre-locking position, on the first narrow side 80 of the first plug housing 2. The first and the second plug housing 2, 3 is for example made of plastics material.

FIG. 2 is a perspective view of the second plug housing 3 looking onto the receiving opening 6. A second contact housing 38, which has second contact openings 39 for introducing electrical contacts, is arranged in the receiving opening 6. In addition, an annular receiving space 40, into which the sleeve-shaped front part 7 of the first plug housing 2 can be inserted, is provided between the contact housing 38 and the housing frame 13.

FIG. 3 is a perspective view of the first plug housing 2 with the contact-securing means 16 in the pre-locking position. The first and the second guide lug 27, 28 are embodied at the first and second wide sides of the front part 7. The sleeve-shaped front part 7 has substantially a rectangularly rounded cross section and extends up to an abutment rim 41 of the first plug housing 2 that surrounds the first plug housing 2 on three sides and is arranged in a plane perpendicular to the longitudinal extension of the front part 7. In the region of the front-side frame part 35, the peripheral abutment rim 41 is interrupted. Adjoining the abutment rim 41, the front part 7 has on a first side face 42 the depression 36 which adjoins the abutment rim 41. It may be seen from FIG. 3 that the obstructing element 17 protrudes beyond the first side face 42 and is arranged above the depression 36. The obstructing element 17 is embodied in the illustrated exemplary embodiment in the form of an angled plate having two lateral partial plates 43, 44. The partial plates 43, 44 surround a part of the wide sides of the front part 7. FIG. 3 clearly shows that the contact-securing means 16 rests with a side rim of the recess 19 directly against a side rim of the guide element 18. In addition, the plate 31 is delimited, opposite the guide element 18, by the guide corners 33, 34. Furthermore, the first and the second guide wall 21, 22 delimit the frame 19 at opposing longitudinal sides. Thus, the contact-securing means 16 cannot be displaced in the plane of the plate 31, so that the holding brackets 22, 23 allow secure locking to the first and the second holding web 24, 25.

FIG. 4 is a perspective view of the contact-securing means 16 which is embodied in the form of an angled sliding element with two partial portions 45, 46, the first partial portion 45 being embodied as the interlocking plate 47 which is plugged, in the mounted state, into the first plug housing 2. The interlocking plate 47 has openings 48 through which, in the pre-locking position of the contact-securing means 16, contacts are inserted from the connection side 49 (FIG. 3) into the first plug housing 2 in contact chambers. In addition, the openings 48 are delimited by obstructing rims 50 which, in the end position of the contact-securing means 16, reduce the size of an insertion opening of the contact chambers and thus prevent extraction of the contacts from the contact chambers.

The second partial portion 46 is formed by the plate 31, the frame 32 and the obstructing element 17. The obstructing element 17 is fastened to the frame 32 so as to be offset vertically downward in the direction toward the interlocking plate 47. In addition, a partial portion 51 of the obstructing element 17 protrudes into the recess 19 and thus delimits the region of the recess 19 that is available for the guide element 18. Furthermore, the first holding brackets 22, 23 have a second locking lug 52 extending out of an end region of the holding brackets 22, 23 into a plane parallel to the plate 31. The contact-securing means 16 is for example made in one piece from plastics material. Depending on the selected embodiment, a peripheral seal 53 may be provided in the region of transition from the inter-locking plate 47 to the plate 31. Thus, the first plug housing 2 is sealed in the region of an insertion opening for the interlocking plate 47.

FIG. 5 shows the first plug housing 2 without the contact-securing means 16. In this case, it is possible to see the insertion opening 54 for the interlocking plate 47 which has a rectangular cross section and in which the seal 53 is arranged. The insertion opening 54 is embodied in cross section in the illustrated exemplary embodiment as a stepped rectangular shape. In a corresponding manner, the interlocking plate 47 also has a stepped rectangular cross section. It may be seen from FIG. 5 that the depression 36 extends, starting from a transverse rim 55 of the upper side face 42 of the front part 7, up to a transverse rim 55 of the guide element 18. Furthermore, the depression 36 extends up to a second transverse rim 83 which is formed on the upper side face 42 set apart from the abutment rim 41 and transversely to the front part 7. In addition, the depression 36 also extends laterally in the form of folded rims 81, 82 up to a defined height of the first and second narrow side faces of the front part 7. The peripheral abutment rim 41 is arranged in a plane perpendicular to the longitudinal direction of the front part 7, the upper side face 42 of the front part 7 being kept free and no abutment rim 41 being provided. A contact 56, which protrudes through the insertion opening 54 up to the front part 7, is plugged schematically in the first plug housing 2.

FIG. 6 is a perspective view of the first plug housing 2 looking onto the front part 7. A first contact housing 57 with first contact openings 58 is provided in the front part 7. A pin end of the contact 56 is guided out through one of the first contact openings 58. In addition, it may clearly be seen that the abutment rim 41 surrounds the front part 7 on three sides. The front part 7 has a second receiving opening 59 into which the second contact housing 38 of the second plug housing 3 is plugged.

FIG. 7 is a view onto the connection side 49 of the first plug housing 2, a contact 56 being plugged into the first plug housing 2 and being interlocked with the aid of the contact-securing means 16 by means of the interlocking plate 47 so as to prevent detachment. In this case, an obstructing rim 50 of the interlocking plate 47 protrudes into an insertion opening 60 and reaches behind the contact 56 on the back. Thus, the contact 56 cannot be accidentally extracted from the first plug housing 2. Thus, the contact 56 is secured in the first plug housing 2 with the aid of the contact-securing means 16 as the second contact-securing means.

FIG. 8 is a schematic view of the contact-securing means 16 and the contact 56 in the interlocked state. In this case, the obstructing rim 50 of the contact-securing means 16 reaches behind a contact body 61 of the contact 56. Locking hocks 84 for locking in the contact chamber are provided on the contact body 61.

FIG. 9 is a partial view of the completely plugged-together plug connector 1 with the first and the second plug housing 2, 3, both the actuating element 10 and the contact-securing means 16 being in the end position. In the end position, the contact-securing means 16 is locked to the first plug housing 2 with the aid of locking recesses 62 formed on the first plug housing 2 and the second locking lugs 52 of the holding brackets 22, 23.

For simple pressing-down of the contact-securing means 16 with the aid of the plate 31, a notch 63 is provided between the first and the second guide corner 33, 34. Thus, the plate 31 can be pressed downward with the aid of a tool or with the aid of a finger, the tool or the finger being inserted into the notch 63.

The abutment rim 41 directly adjoins, in the illustrated position, the front-side edge region 37 of the housing frame 13 of the second plug housing 3. Thus, the obstructing element 17 is inserted at least partially in the housing frame 13 or arranged at least below the actuating element 10.

FIG. 10 shows the completely mounted plug connector 1 from FIG. 9, the actuating element 10 and the housing frame 13 not being shown. In this case, it may clearly be seen that the obstructing element 17 is arranged in the depression 36 and is inserted in the housing frame 13. If the contact-securing means 16 is in the pre-locking position, then the obstructing element 17 protrudes upward beyond the upper side face 42 of the guide part 7 and can thus not be inserted into the second plug housing 3, as the annular receiving space 40 is adapted to the cross section of the guide part 7. Thus, the first plug housing 2 can be drawn into the second plug housing 3 with the aid of the actuating element 10 only once the contact-securing means 16 is in the end position, i.e. in obstructing position, and the obstructing element 17 is lowered in the depression 36.

FIG. 11 is a schematic view of a further embodiment of a plug connector 1 in which the obstructing element 17 of the contact-securing means 16 is guided only up to the abutment rim 41. However, in this embodiment, the actuating element 10 extends into the region above the obstructing element 17. The vertical position of the actuating element 10 in the end position is arranged lower than the vertical position of the obstructing element 17 in the pre-locking position of the contact-securing means 16. In addition, the vertical position of the obstructing element 17 in the end position of the contact-securing means 16 is arranged below the vertical position of the actuating element 10 in the end position. Thus, in this embodiment too, the actuating element 10 can be brought into the end position only once the contact-securing means 16 is in the end position. It is thus not necessary for the obstructing element 17 always to be inserted into the second plug housing 3. It is sufficient if the movement of the actuating means 10 from the pre-locking position into the end position is released only once the contact-securing means 16 is in the end position.

FIG. 12 is a side view of the embodiment of the plug connector 1 from FIG. 11. In this case, the contact-securing means 16 is in the pre-locking position. The actuating element 10 is also in the pre-locking position. The first and the second plug housing 2, 3 are also in the pre-locking position, the first and the second guide lug of the front part 7 engaging with the first and the second guide groove and with the first and second guide tracks of the actuating element 10. For complete pushing-together of the first and the second plug housing 2, 3, it is now necessary to insert the actuating element 10 deeper into the second plug housing 3. The actuating element 10 is embodied in the illustrated embodiment in such a way that a partial portion 85 of the actuating element 10 is arranged above the obstructing element 17. The obstructing element 17 blocks the insertion of the actuating element 10 into the end position by abutting against the partial portion 85. Thus, the first and the second plug housing 2, 3 cannot be completely plugged into each other via actuation of the actuating element 10.

Only once the contact-securing means 16 has been plugged into the end position, i.e. deeper into the first plug housing 2, does the obstructing element 17 clear the way for insertion of the actuating element 10 into the end position and thus into the second plug housing 3. Thus, complete plugging-together of the first and the second plug housing 2, 3 in the pre-locking position of the contact-securing means can be prevented only as a result of the blocking of the path of movement of the actuating means 10. In the embodiment of FIG. 12, the contact-securing means 16 is embodied with the obstructing element 17 in such a way that the obstructing element 17 does not extend laterally up to the front part 7. In this embodiment, the obstructing element 17 is not inserted into the second plug housing 3 even when the first and second plug housings 2, 3 are completely plugged together. Thus, the path of movement of the second plug housing is not blocked by the contact-securing means 16.

However, depending on the selected embodiment, the contact-securing means 16 can additionally be embodied with the obstructing element in such a way that the obstructing element protrudes laterally beyond the front part 7 and is also inserted, in the completely plugged-together state, into the second plug housing 3. In this embodiment, both the path of movement of the actuating means 10 and the path of movement of the second plug housing 3 are blocked by the obstructing element when the contact-securing means 16 is in the pre-locking position.

FIG. 13 shows a further embodiment of a first plug housing 2 in which the plate 31 is embodied as a continuous plate and no recess 19 is provided. In this embodiment, the plate 31 is delimited on three sides on a connection side 49 by an edge 64 which is angled on both sides. In addition, the first plug housing 2 has two lateral webs 65, 66 which are arranged laterally set apart from angled partial edges 67, 68 of the edge 64. The first and the second web 65, 66 additionally delimit the plate 31 at opposing longitudinal sides. In the notches between the first web 65 and the first partial edge 67 and between the second web 66 and the second partial edge 68, the holding brackets 22, 23 are guided laterally downward. The first and the second web 65, 66 protrude laterally beyond the upper side face 42 of the first plug housing 2 and additionally merge downward, along the wide side faces, with side webs 69. Third and fourth locking lugs 71 are embodied on the side webs 69. On the third or fourth locking lug 71, first locking lugs of the first and the second holding bracket 22, 23 are locked in the pre-locking position.

The plate 31 is guided out beyond the abutment rim 41 and reaches with two side rims 73, 74 at opposing sides in each case behind the abutment rim 41. This provides different mounting and guiding of the obstructing element 17 from the preceding exemplary embodiment.

In this embodiment, a front rim 75 of the plate 31 also forms an abutment rim for the second plug housing 3.

For locking of the contact-securing means 16 in the end position, locking recesses 76, with which second locking lugs 52 (not shown) of the holding brackets 22, 23 engage, are provided laterally on the first plug housing 2.

The obstructing element 17 protrudes in this embodiment beyond the abutment rim 41 and is arranged above a depression 36 of the guide part 7. FIG. 12 shows the contact-securing means 16 in the pre-locking position. After the pressing of the contact-securing means 16 into the end position, i.e. into the locking position, the obstructing element 17 is moved back into the depression 36, so that the first contact housing 2 can be inserted into the second contact housing 3 up to the abutment rim 41.

In a further embodiment of FIG. 13, the obstructing element 17 can extend only up to the abutment rim 41 and the actuating element 10 can protrude beyond the abutment rim 41, as is illustrated schematically in FIGS. 11 and 12.

FIG. 14 shows a further embodiment of a contact-securing means 16 with an interlocking plate 47 which has, opposing one another at two longitudinal sides, laterally open openings 48 in the form of recesses. The interlocking plate 47 is embodied in the form of a pin which interlocks the contacts with opposing side rims.

1-15. (canceled)

16. A plug connector with a first plug housing and a second plug housing which are plugged into each other, wherein there is provided in the first plug housing a contact-securing means which can be brought from a pre-locking position into an end position, in which the contact-securing means protects contacts of the first plug housing from accidental detachment, there being movably mounted on the second plug housing an actuating means which is operatively connected to the first plug housing, the first and the second plug housing being plugged together as a result of a movement of the actuating means from a pre-locking position into an end position, the contact-securing means having an obstructing element, the obstructing element protruding into the path of movement of the actuating means or the second plug housing and preventing plugging-together of the first and the second plug housing when the contact-securing means is not in the end position.

17. The plug connector according to claim 1, wherein the actuating means is embodied as a slide, and wherein the obstructing element obstructs, in the pre-locking position of the contact-securing means, sliding of the slide into the end position.

18. The plug connector according to claim 1, wherein there are provided on the first plug housing and on the contact-securing means first locking means allowing locking of the contact-securing means in the pre-locking position.

19. The plug connector according to claim 1, wherein there are provided on the first plug housing and on the contact-securing means second locking means allowing locking of the contact-securing means in the end position.

20. The plug connector according to claim 1, wherein the contact-securing means has a recess, a guide element of the first plug housing protruding into the recess.

21. The plug connector according to claim 1, wherein the first plug housing has a depression in a region which is arranged, in the plugged state, in the second plug housing, the obstructing element being arranged, in the pre-locking position of the contact-securing means, at least partially outside the so that the first and second plug housings cannot be gether, the obstructing element being arranged, in the end position of the contact-securing means, with at least a partial portion completely in the depression, so that the first and second plug housings can be inserted one inside the other.

22. The plug connector according to claim 1, wherein the first plug housing has two parallel guide webs which guide a partial portion of the contact-securing means on two sides.

23. The plug connector according to claim 1, wherein the contact-securing means is embodied in the form of an angled sliding element with two partial portions, the first partial portion having an interlocking plate for securing the contacts, the second partial portion having the obstructing element.

24. The plug connector according to claim 1, wherein the contact-securing means has at least one flexible bracket arm which laterally surrounds the first plug housing and fixes the contact-securing means on the first plug housing in the pre-locking position and in the end position.

25. The plug connector according to claim 9, wherein a second bracket arm is provided for holding the contact-securing means, the second bracket arm being embodied mirror-symmetrically to the first bracket arm.

26. The plug connector according to claim 8, wherein the interlocking plate protrudes into the plug housing and obstructs, depending on the position, an insertion opening for a contact.

27. The plug connector according to claim 8, wherein the securing plate is embodied in the form of a web with lateral recesses arranged on both sides, the recesses on both sides being delimited by obstructing faces, the recesses clearing, in the pre-locking position of the contact-securing means, insertion openings of the contact chambers for inserting the contacts, and the obstructing faces at least partially obstructing, in the end position of the contact-securing means, the insertion opening of the contact chamber.

28. The plug connector according to claim 1, wherein the obstructing element is embodied in the form of a plate which is angled on both sides, the two angled partial plates laterally surrounding the first plug housing.

29. The plug connector according to claim 1, wherein the actuating element is arranged above the obstructing element, the obstructing element blocking, in the pre-locking position of the contact-securing means, pressing of the actuating element into the second plug housing and into the end position.

30. First plug housing according to claim 1.
